(19) United States
(12) Patent Application Publication
(10) Pub. No.: US 2023/0419868 A1
(43) Pub. Date: Dec. 28, 2023

(54) LIGHT-EMITTING LABEL AND LIGHT-EMITTING LABEL SYSTEM COMPRISING SAME

(71) Applicant: MEIYUME (SHENZHEN) LIMITED, Shenzhen (CN)

(72) Inventors: Kwok Lung HO, Hong Kong (CN); Wai Lung CHAN, Hong Kong (CN); Hon Kei LEE, Hong Kong (CN)

(21) Appl. No.: 18/257,883

(22) PCT Filed: Nov. 17, 2021
(86) PCT No.: PCT/CN2021/131123

§ 371 Date: Jun. 16, 2023

(30) Foreign Application Priority Data
Dec. 18, 2020 (CN) 202023057618.1

(51) Int. Cl. G09F 13/04

(52) U.S. Cl. CPC G09F 13/0477; G09F 13/0422; G09F 13/0413

(57) ABSTRACT

A light-emitting label (100, 210, 300, 400, 500) and a light-emitting label system (200) comprising same. The light-emitting label (100, 210, 300, 400, 500) comprises: a back plate (110, 310, 410, 510), at least one battery (120, 320, 420, 520), a light guide plate (140, 340, 440, 540), a flexible printed circuit (150, 350, 450, 550), and a pattern layer (160, 360, 460, 560). The flexible printed circuit (150, 350, 450, 550) comprises a substrate surface (152) and an electrically-conductive surface (154) comprising a plurality of light-emitting diodes (1542) arranged thereon. The light guide plate (140, 340, 440, 540) comprises a front light guide surface (142) and a rear light guide surface (144) opposite thereto. The pattern layer (160, 360, 460, 560) fixes the flexible printed circuit (150, 350, 450, 550) onto the front light guide surface (142), and the back plate (110, 310, 410, 510) seals the at least one battery (120, 320, 420, 520) onto the rear light guide surface (144). The light guide plate (140, 340, 440, 540) further comprises a light guide portion (1410) and a receiving portion (1420, 4420). The electrically-conductive surface (154) of the flexible printed circuit (150, 350, 450, 550) is positioned to be juxtaposed to the front light guide surface (142), and the plurality of light-emitting diodes (1542) extend into the receiving portion (1420, 4420) such that the plurality of light-emitting diodes (1542) emit light in a direction of a distal side of the light guide portion (1410). The light guide plate (140, 340, 440, 540) further comprises a slot (1417, 3417) for allowing the flexible printed circuit (150, 350, 450, 550) to be electrically connected to the at least one battery (120, 320, 420, 520). The light-emitting label (100, 210, 300, 400, 500) can achieve a high-luminosity and uniform light-emitting effect, and is waterproof and recyclable.

### TECHNICAL FIELD

The present application relates to the technical field of labels, and in particular to a light-emitting label.

### BACKGROUND ART

Labels and packages demonstrate the first impression of products when potential customers see the products. Light-emitting labels increase the visual appeal of the products and have an exquisite and luxurious appearance. In addition, the light-emitting labels provide better contrast to product labels, so that the product labels are easy to distinguish. Therefore, there is a need for a light-emitting label and a corresponding device therefor to meet corresponding technical requirements and industrial applications. Some light-emitting labels available on the market have many defects, such as nonuniform overall brightness of the labels, unsatisfactory waterproof effect, large overall thickness of the labels containing batteries, and affecting the attractiveness. There is a need for an improved light-emitting label and a light-emitting label system comprising same.

### SUMMARY OF THE INVENTION

In view of the background, the technical problem to be solved by the present application is to provide an improved light-emitting label and a light-emitting label system comprising same, so as to solve at least part of the problems of conventional light-emitting labels.

In some embodiments, to solve the above technical problems, the present application provides a light-emitting label, comprising: (a) a back plate comprising a sealing surface and a target attachment surface opposite to the sealing face; (b) at least one battery; (c) a light guide plate comprising a front light guide surface and a rear light guide surface opposite to the front light guide surface; (d) a flexible printed circuit comprising a substrate surface and an electrically-conductive surface opposite to the substrate surface, the electrically-conductive surface comprising a plurality of light-emitting diodes arranged on the electrically-conductive surface; and (e) a pattern layer; wherein the pattern layer fixes the flexible printed circuit onto the front light guide surface, and the back plate seals the at least one battery onto the rear light guide surface; the light guide plate further comprises a light guide portion comprising a proximal side and a distal side between which a length is defined, and a receiving portion shaped and sized to receive the flexible printed circuit; the electrically-conductive surface is positioned to be juxtaposed to the front light guide surface, and the plurality of light-emitting diodes extend into the receiving portion such that the plurality of light-emitting diodes emit light in a direction of the distal side; and the light guide plate further comprises: a slot for allowing the flexible printed circuit to be electrically connected to the at least one battery.

Other exemplary embodiments are described herein.

The present application has many technical advantages. In some embodiments, the light-emitting label provided by the present application can achieve a high-luminosity and uniform light-emitting effect even on a curved target surface. In some embodiments, the light-emitting label provided by the present application avoids a local light spot region and a local shadow region generated by direct light beams, greatly increases an available area of the uniform light guide part, and makes the overall light-emitting effect more uniform. In some embodiments, the light-emitting label provided by the present application has an exquisite structure and a smaller overall thickness. For example, the overall thickness may reach about 2.1 mm or less. In some embodiments, the light-emitting label provided by the present application has a good waterproof performance and is suitable for liquid containers such as wine bottles and beverage bottles. In some embodiments, the light-emitting label provided by the present application is rechargeable and reusable, so that the cost is saved, and the environment is protected. In some embodiments, the light-emitting label system provided by the present application can charge a plurality of light-emitting labels simultaneously, facilitating simultaneous use of the plurality of light-emitting labels.

### BRIEF DESCRIPTION OF THE DRAWINGS

FIG. 1A is a schematic perspective view of an overall appearance of a light-emitting label according to an embodiment of the present application;

FIG. 1B is a schematic view of the overall back side of the light-emitting label of the embodiment shown in FIG. 1A;

FIG. 1C is an exploded structural schematic perspective view of the front side of the light-emitting label of the embodiment shown in FIG. 1A;

FIG. 1D is an exploded structural schematic perspective view of the back side of the light-emitting label of the embodiment shown in FIG. 1A;

FIG. 1E is a structural schematic perspective view of a light guide plate in the embodiment shown in FIG. 1A;

FIG. 1F is a schematic view of the back side of the light guide plate in the embodiment shown in FIG. 1E;

FIG. 1G is a schematic partial enlarged view of the light guide plate in the embodiment shown in FIG. 1F, with (1), (2), (3) and (4) being partial enlarged regions of corresponding circles of FIG. 1F to show a plurality of dots in each dot portion;

FIG. 1H is a schematic perspective view of the light-emitting label of the embodiment shown in FIG. 1A assembled to a target surface;

FIG. 2A is a schematic view of the overall appearance of a light-emitting label system according to an embodiment of the present application;

FIG. 2B is a schematic top view of the light-emitting label system of the embodiment shown in FIG. 2A;

FIG. 2C is a schematic cross-sectional view of the light-emitting label system of the embodiment shown in FIG. 2A, with (X) being a partial enlarged view of a corresponding circle;

FIG. 3A is an exploded structural schematic view of a light-emitting label according to another embodiment of the present application;

FIG. 3B is a longitudinal cross-sectional view of the light-emitting label shown in FIG. 3A, with (Y) and (Z) being respectively partial enlarged views of corresponding circles;

FIG. 4 is an exploded structural schematic view of a light-emitting label according to another embodiment of the present application;

FIG. 5 is an exploded structural schematic view of a light-emitting label according to another embodiment of the present application; and

FIG. 6 is a broken-line graph showing relative luminosities of light guide plates having different dot matrix arrangements according to another embodiment of the present application, at relative positions about 30%, about 60% and about 83.5% of a relative distance from a light source (relative positions of a proximal side and a distal side) respectively.

### DETAILED DESCRIPTION OF EMBODIMENTS

In order to make the technical problems to be solved, the technical solutions, and the beneficial effects of the present application clearer, the present application will be described in further detail below with reference to the accompanying drawings and embodiments. It should be understood that the specific embodiments described herein are merely used to explain the present application and are not intended to limit the present application.

In the present application, for ease of description, relative positions and directions of a light-emitting label, such as front, rear, upper, lower, top end, bottom end, left, right, inner and outer, are defined by taking the state where the label is placed in normal use as the reference state. Unless otherwise indicated, the term “back side” refers to the position and direction towards a target surface to be attached, and the term “front side” refers to the opposite position and direction away from the target surface to be attached.

In the present application, the term “comprising” means including, but not limited to, the following elements, that is, not excluding other elements.

In the present application, the terms “about” and “approximately” refer to accuracy intervals that would be understood by those skilled in the art so as to still ensure the technical effects of the features discussed. The terms generally denote a deviation of 10%, preferably 5%, from the indicated value.

In the present application, by “light-emitting label” is meant an identifier attached to a target surface of an object (such as a container) and having a light source element (such as a light-emitting diode), which may contain information or symbols related to the object.

In the present application, by “flexible printed circuit board” is meant an electrically-conductive circuit bonded on a flexible substrate carrying an electrical signal.

In the present application, by “label” is meant an identifier attached to a target surface of an object (such as a container), which may contain information or symbols related to the object.

In the present application, the terms “container” and “bottle” are interchangeable and are containers for holding, storing, and transporting objects or materials, such as liquid. As an example, the container may have a curved or flat surface. Examples of the bottle include, but are not limited to, a beer bottle, a wine bottle, a champagne bottle, and other bottles for carrying liquid used or consumed by customers.

In the present application, by “light guide plate” is meant a layer that is at least partially light-transmissible, and distributes light from a light source in the entire length and/or thickness of a region. As an example, at least part of the light guide plate has a region with a light guide dot matrix. As an example, the light guide plate is made of a transparent plastic.

In the present application, the expression “attachment” refers to a direct or indirect physical joining or connection to other elements. Indirect physical joining or connection means that there may be one or more additional elements between two elements.

In the present application, the expression “adhesion” refers to a direct or indirect physical joining or connection to other elements by means of a viscous substance. As an example, the viscous substance may be a single-sided or double-sided tape/gummed paper, or an adhesive such as glue.

A light-emitting label according to an exemplary embodiment is provided as an example, and an example of one light-emitting label should not be interpreted as an example for limiting another light-emitting label. For ease of description, all subsequent figures with the same reference numerals refer to the same parts and will not be repeated in the description of each figure. Furthermore, the light-emitting labels discussed in different figures may be added to or interchanged with configurations in other figures. In addition, specific data values (such specific quantities, numbers, and categories) or other specific information should be interpreted as illustrative so as to discuss exemplary embodiments. The specific information is not provided to limit the exemplary embodiments. Any elements described herein in the singular form may be a plurality of elements (namely, “an” element described may be a plurality of elements).

In an aspect, the present application provides a light-emitting label, comprising: (a) a back plate comprising a sealing surface and a target attachment surface opposite to the sealing face; (b) at least one battery; (c) a light guide plate comprising a front light guide surface and a rear light guide surface opposite to the front light guide surface; (d) a flexible printed circuit comprising a substrate surface and an electrically-conductive surface opposite to the substrate surface, the electrically-conductive surface comprising a plurality of light-emitting diodes arranged on the electrically-conductive surface; and (e) a pattern layer; wherein the pattern layer fixes the flexible printed circuit onto the front light guide surface, and the back plate seals the at least one battery onto the rear light guide surface; the light guide plate further comprises a light guide portion comprising a proximal side and a distal side between which a length is defined, and a receiving portion shaped and sized to receive the flexible printed circuit; the electrically-conductive surface is positioned to be juxtaposed to the front light guide surface, and the plurality of light-emitting diodes extend into the receiving portion such that the plurality of light-emitting diodes emit light in a direction of the distal side; and the light guide plate further comprises: a slot for allowing the flexible printed circuit to be electrically connected to the at least one battery.

In an optional embodiment, the rear light guide surface further comprises a central indent portion, and the central indent portion and the sealing surface form a space for accommodating the at least one battery.

In an optional embodiment, a reflective layer is further comprised. The reflective layer comprises: a front reflective surface attached to the rear light guide surface; and a rear reflective surface attached to the at least one battery and/or the sealing surface.

In an optional embodiment, the plurality of light-emitting diodes are arranged in a row at equal intervals; and the flexible printed circuit further comprises a push switch disposed proximal to the center of the row.

In an optional embodiment, the back plate is or comprises a double-sided sticker or a removable sticker. In an optional embodiment, the back plate is a double-sided adhesive layer.

In an optional embodiment, the light-emitting label further comprises a wireless charging component.

In an optional embodiment, the light-emitting label is configured to be detachably received in a bracket attachable to a target surface.

In an optional embodiment, the at least one battery is rechargeable, and the back plate is configured to electrically connect the at least one battery to a charger.

In an optional embodiment, the light guide portion comprises a plurality of dots which scatter light generated from the plurality of light-emitting diodes.

In an optional embodiment, the light guide portion further comprises a plurality of dot portions which are consecutively arranged, wherein the sizes of a plurality of dots in each dot portion increase with increasing distance from the light-emitting diodes. In an optional embodiment, the light guide portion further comprises: a first dot portion, a second dot portion, a third dot portion and a fourth dot portion which are consecutively arranged with increasing distance from the plurality of light-emitting diodes, wherein each dot portion comprises a plurality of equidistantly spaced, uniformly sized dots which scatter the light generated from the plurality of light-emitting diodes, wherein the sizes of a plurality of dots in each dot portion increase with increasing distance from the light-emitting diodes. In an optional embodiment, the vertical and horizontal distances between the centers of any two closest dots are equidistant.

In an optional embodiment, the diameters of the dots in the first dot portion, the second dot portion, the third dot portion and the fourth dot portion are respectively 0.2 mm, 0.3 mm, 0.4 mm and 0.5 mm, and the vertical and horizontal distances between the centers of any two closest dots are both 0.5 mm. In an optional embodiment, each dot may be a protrusion protruding from the rear light guide surface, or a recess recessed from the rear light guide surface, or may be flat printed on the rear light guide surface or formed by laser engraving.

In an optional embodiment, the surface area ratio of the first dot portion to the second dot portion to the third dot portion to the fourth dot portion is about 21:28:28:23. In an embodiment, the surface area ratio of the first dot portion to the second dot portion to the third dot portion to the fourth dot portion is 21:28:28:23.

In an optional embodiment, the light-emitting label is generally in the shape of a curved surface.

In an optional embodiment, the light-emitting label is generally in the shape of a trapezoidal curved surface.

In another aspect, the present application provides a light-emitting label, comprising: (a) a back plate comprising a sealing surface and an opposite target attachment surface; (b) at least one battery; (c) a reflective layer comprising a front reflective surface and a rear reflective surface; (d) a light guide plate comprising a front light guide surface and an opposite rear light guide surface; (e) a flexible printed circuit comprising a substrate surface and an opposite electrically-conductive surface, the electrically-conductive surface comprising a plurality of light-emitting diodes arranged thereon; and (f) a pattern layer; wherein the pattern layer fixes the flexible printed circuit onto the front light guide surface, the back plate seals the reflective layer and the at least one battery onto the rear light guide surface, and the front reflective surface is juxtaposed to the rear light guide surface; the light transmitting panel further comprises: a light transmitting portion, comprising a proximal side and a distal side between which a length is defined, and comprising a plurality of dots for scattering light generated from the plurality of light-emitting diodes; and a receiving portion shaped and sized to receive the flexible printed circuit; the electrically-conductive surface is positioned to be juxtaposed to the front light guide surface, and the plurality of light-emitting diodes extend into the receiving portion such that the plurality of light-emitting diodes emit light in a direction traversing across the length; and the light guide plate further comprises: an insertion slot for allowing the flexible printed circuit to be electrically connected to the at least one battery.

In another aspect, the present application provides a light-emitting label system, comprising: one or more light-emitting labels according to any one of the above embodiments; and a charger configured to removably receive and electrically connect the one or more light-emitting labels so as to charge the at least one battery in each of the one or more light-emitting labels.

In another aspect, a method for manufacturing a light-emitting label is provided, the method comprising one or more of the following manufacturing steps:
1. A back plate, at least one battery, a light guide plate, a flexible printed circuit, and a pattern layer are provided. The light guide plate comprises a front light guide surface and an opposite rear light guide surface, a light guide portion, a receiving portion, and a slot. The flexible printed circuit comprises a substrate surface and an opposite electrically-conductive surface. The electrically-conductive surface comprises a plurality of light-emitting diodes arranged thereon.
2. The electrically-conductive surface is positioned to be juxtaposed to the front light guide surface such that the plurality of light-emitting diodes extend into the receiving portion.
3. The flexible printed circuit is electrically connected, through the slot, to the at least one battery arranged at the rear light guide surface.
4. The flexible printed circuit is fixed onto the front light guide surface by the pattern layer.
5. The at least one battery is sealed onto the rear light guide surface by the back plate.
6. Optionally, a reflective layer is provided. The reflective layer may be attached to the rear light guide surface.
7. Optionally, an interlayer and an adhesion layer are provided. The interlayer may be attached to the back plate by means of the adhesion layer.

The various aspects of the present invention will be further described below with reference to the accompanying drawings:

### Embodiment I

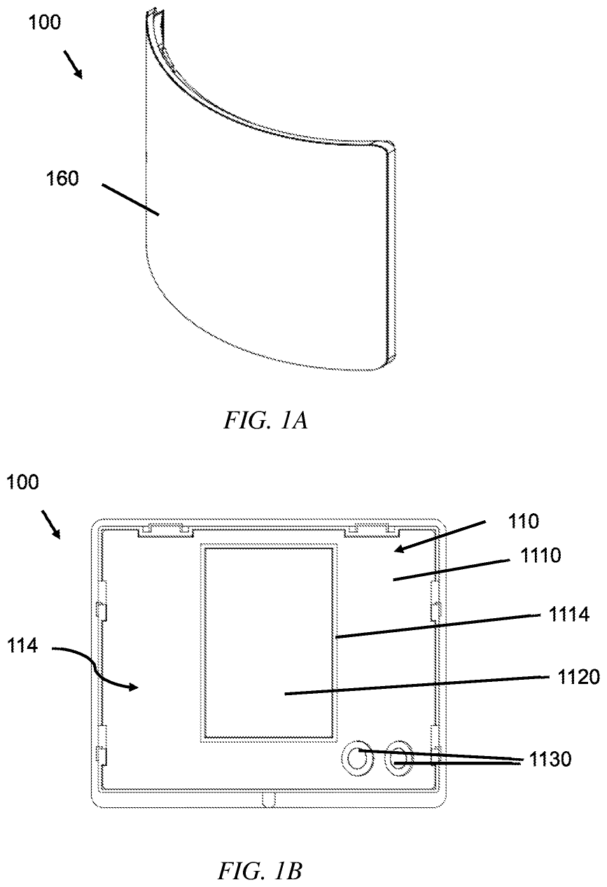

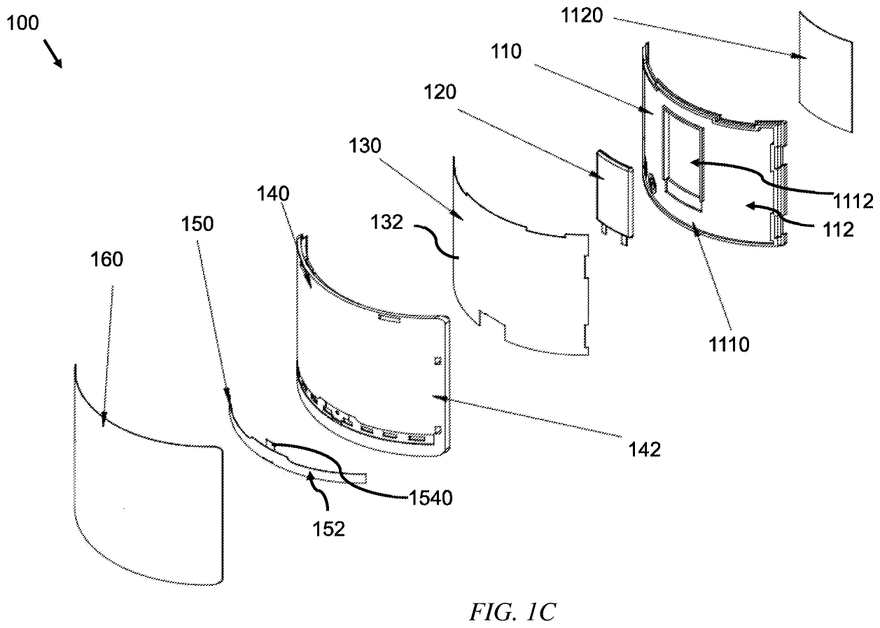

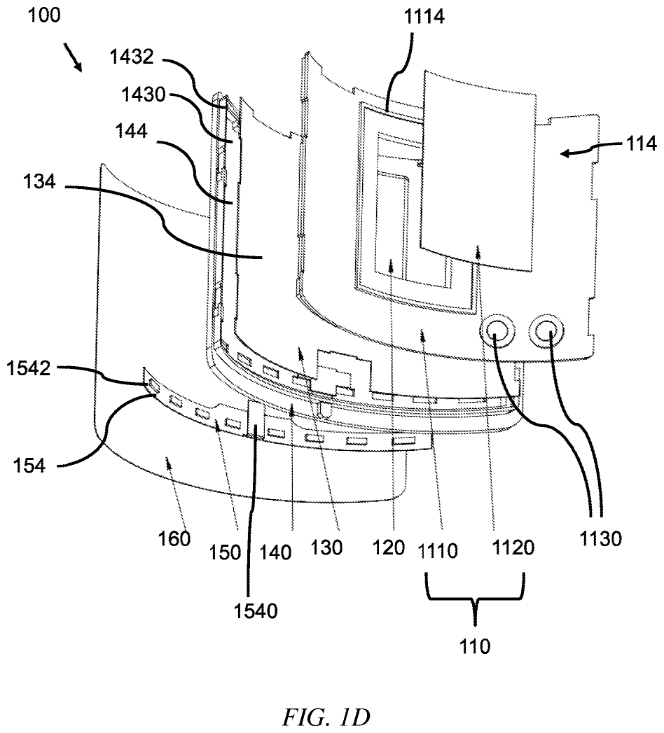

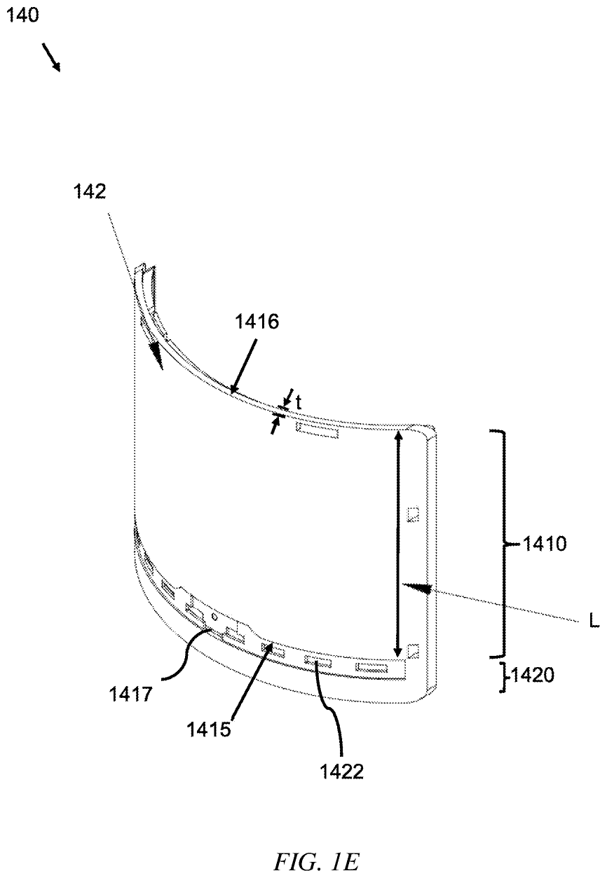

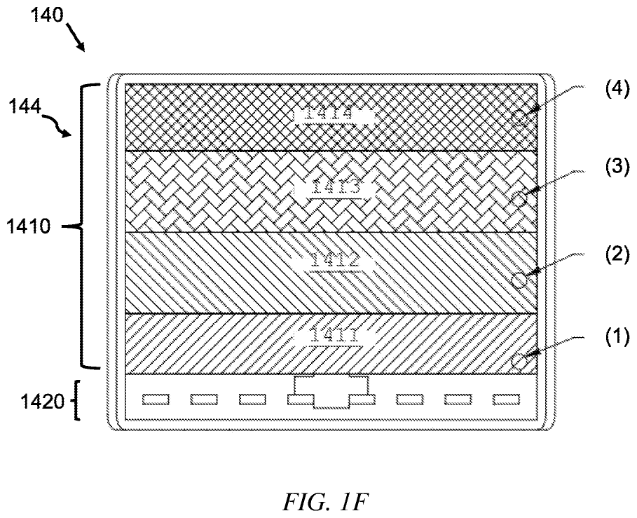

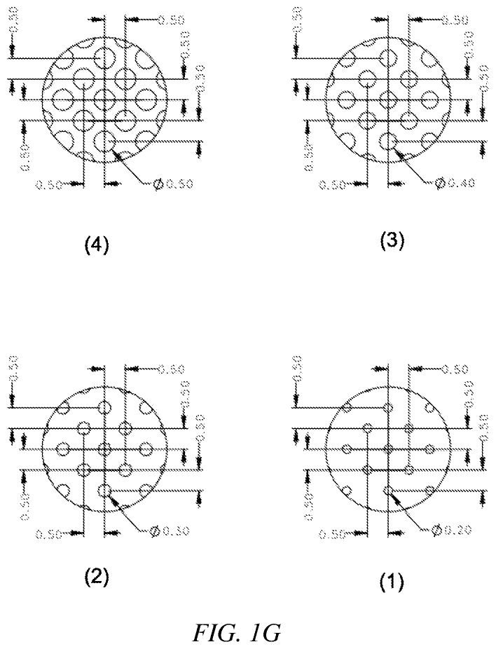

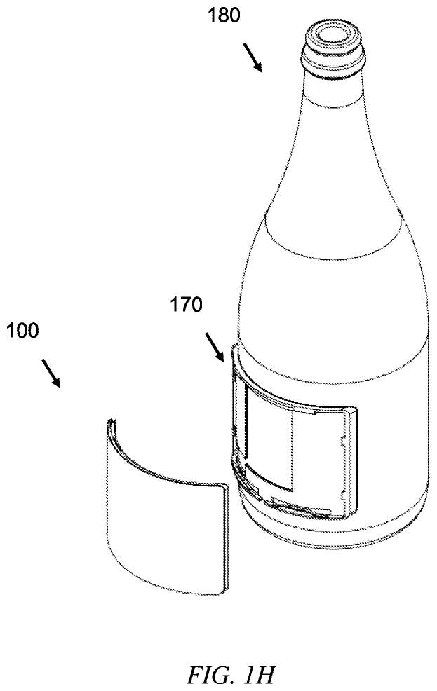

FIGS. 1A-1H show an exemplary light-emitting label 100 formed by a plurality of layers, which sequentially comprises from the back side to the front side: a back plate 110, a battery 120, a reflective layer 130, a light guide plate 140, a flexible printed circuit 150, and a pattern layer 160. As an example, the plurality of layers may be attached together by means of pasting, snap-fitting and/or ultrasonic welding. The light-emitting label 100 may be attached directly or indirectly to a target surface. In this embodiment, the light-emitting label 100 is generally in the shape of a curved surface, so as to be adaptively attached to a curved target surface (such as a bottle 180) (FIG. 1H). In this embodiment, the light-emitting label 100 is configured to be detachably attached to a bracket 170 of the target surface in a snap-fit manner so as to be indirectly attached to the curved target surface, facilitating removal and assembly of the light-emitting label 100. In other embodiments, the light-emitting label 100 may be generally in a planar shape. In these embodiment, the light-emitting label 100 is generally in the shape of a rounded rectangle. In other embodiments, the light-emitting label 100 may be generally in other shapes, such as a circle, a heart, a polygon, a trapezoid and a rounded trapezoid with a curved or flat surface.

In some embodiments, the light-emitting label 100 further comprises a wireless charging component (not shown) electrically connected to the battery 120, so that the light-emitting label 100 can be wirelessly charged to facilitate reuse. Referring to FIGS. 1B-1D, in this embodiment, the back plate 110 comprises a front sealing surface 112 and an opposite target attachment surface 114. The back plate 110 further comprises a back plate body 1110, a back cover sheet 1120 and two charging contacts 1130 (FIG. 1B). The back plate body 1110 comprises a hollow groove 1112 sized and shaped to accommodate at least a part of the battery 120 in the back plate body 1110, so as to reduce the overall thickness of the light-emitting label (FIG. 1C). As an example, the overall thickness of the back plate 110 may be substantially equal to the thickness of the battery 120 such that at least a part of the battery 120 can be accommodated within the hollow groove 1112. As an example, the back plate body 1110 may be made of a plastic material such as a general-purpose polystyrene (GPPS), or polystyrene (PS). On the back side, the back plate body 1110 further comprises a limiting frame 1114 (FIGS. 1B and 1D) sized and shaped to define the back cover sheet 1120 in place so as to completely cover the hollow groove 1112. The back cover sheet 1120 is located on the back side of the back plate body 1110, and is sized and shaped to cover and seal the hollow groove 1112 (and the battery 120 accommodated therein) on the back side of the back plate 110. As an example, the back cover sheet 1120 may be made of a plastic sheet material such as a polyester film, polyethylene terephthalate (PET), or MYLAR. The back plate 110 may seal the battery 120 on the back side (namely, the rear light guide surface 144) of the light guide plate 140 by means of, for example, a waterproof sticker or heat sealing. The charging contacts 1130 are configured as electrical connection points across the entire thickness of the back plate to electrically connect the battery 120 from the front side of the back plate to the back side of the back plate, and thus may be electrically connected to a charger (not shown) so as to charge the battery 120, facilitating charging and reusing the light-emitting label to save the cost and protect the environment. As an example, at least a part of the charging contacts 1130 is made of an electrically-conductive metal such as copper.

In this embodiment, the battery 120 is a rechargeable battery, such as a lithium battery or a lithium polymer battery (FIG. 1C). As an example, the battery 120 may have a voltage of 3.7 V and a battery capacity of 400 mAh, which are enough to provide power to the plurality of light-emitting diodes for continuous use for at least a few hours or even a few days. As an example, the battery capacity may range from 100 mAh to 400 mAh. As an example, the battery capacity may range from 150 mAh to 350 mAh, depending on the size of the light-emitting label, the number of light-emitting diodes and actual demands. In this embodiment, the light-emitting label 100 comprises one battery 120. As an example, the light-emitting label 100 may comprise a plurality of batteries 120, such as two, three or more.

In this embodiment, the reflective layer 130 comprises: a front reflective surface 132 on the front side, which is attached to the rear light guide surface 144; and a rear reflective surface 134 on the back side, which is attached to the battery 120 and/or the sealing surface 112 of the back plate 110 (FIGS. 1C-1D). The front reflective surface 132 is juxtaposed to the rear light guide surface 144. As an example, the front reflective surface 132 of the reflective layer 130 may be provided with an adhesive layer to be adhered to the back side (namely, the rear light guide surface 144) of the light guide plate. As an example, the rear reflective surface 134 of the reflective layer 130 may be provided with an adhesive layer to be adhered to the battery 120 and the front side (namely, the sealing surface 112) of the back plate. As an example, only the front reflective surface 132 is a reflective plane. As an example, both the front reflective surface 132 and the rear reflective surface 134 are reflective surfaces. The reflective layer 130 is sized and shaped to be closely attached to the back side (namely, the rear light guide surface 144) of the light guide plate 140, and the light efficiency is optimized between the reflective layer 130 and the light guide plate 140 by capturing (reflecting and refracting) the light emitted from the plurality of light-emitting diodes, which is conductive to achieving a high-luminosity and uniform light-emitting effect. In other embodiments, the light-emitting label may not comprise the reflective layer 130.

Referring to FIGS. 1C-1F, the light guide plate 140 comprises a front light guide surface 142 on the front side and a rear light guide surface 144 on the back side. A thickness t (FIG. 1E) is defined between the front light guide surface 142 and the rear light guide surface 144. As an example, the light guide plate 140 may be made of a light transmitting material. The front light guide surface 142 is attached to the back side (namely, the electrically-conductive surface 154) of the flexible printed circuit 150 and the back side of the pattern layer 160, and the rear light guide surface 144 is attached to the front side (namely, the front reflective surface 132) of the reflective layer 130. The light guide plate further comprises a light guide portion 1410 located at an upper portion and a receiving portion 1420 located at a lower portion (FIGS. 1E-1F). A lower end horizontal line of the light guide portion 1410 forms a proximal side 1415, while an upper end horizontal line forms a distal side 1416, and the length L of the light guide portion 1410 is defined between the proximal side 1415 and the distal side 1416 (FIG. 1E). The receiving portion 1420 is shaped and sized to receive the flexible printed circuit 150. In this embodiment, the receiving portion 1420 comprises an elongated recessed portion arranged on the front light guide surface 142 and a trapezoidal recessed portion located on the elongated recessed portion, and the two recessed portions form a recessed space basically matched with a substrate of the flexible printed circuit in shape and size. The elongated recessed portion in the receiving portion 1420 further has a plurality of through holes 1422 arranged in a row at equal intervals, and each through hole 1422 is sized and shaped to be suitable for receiving a respective light-emitting diode on the flexible printed circuit 150, so that a light-emitting portion thereof extends substantially into the receiving portion, and each light-emitting diode emits light in a direction from the proximal side 1415 to the distal side 1416. As an example, the plurality of light-emitting diodes are configured such that the entire length L and thickness t of the light guide portion 1410 are enough to receive the light emitted from the light-emitting diodes so as to uniformly guide the light. In this embodiment, eight through holes 1422 identical in size are provided. In other embodiments, the number, shape and distribution positions of through holes 1422 may be adjusted according to actual demands. In other embodiments, the through holes 1422 may be replaced with recessed portions in any shapes, which are sized and shaped to receive the light-emitting diodes and/or other electronic elements. A middle portion of the receiving portion 1420 may further comprise a middle recessed portion having a larger recessed degree, so as to adapt to an electronic element having a certain thickness on the flexible printed circuit, such as a push switch. In this embodiment, the middle recessed portion is substantially “T”-shaped. In other embodiments, the specific shape and recessed degree of the receiving portion may be adjusted according to actual contours and the thicknesses of the flexible printed circuit 150 and the electronic element arranged on the flexible printed circuit, to exactly form a region matched with the contour of the flexible printed circuit 150, so that the overall thickness of the light-emitting label 100 is decreased, the appearance is more attractive, and the waterproof performance is better. The receiving portion 1420 of the light guide plate 140 further comprises a slot 1417 which allows the flexible printed circuit 150 to be electrically connected to at least one battery 120 located behind the light guide plate 140. In this embodiment, the slot 1417 is located in the middle of the receiving portion 1420 and has an enough size to allow an extension portion 1540 of the flexible printed circuit 150 to pass through the light guide plate 140 from the front light guide surface 142 through the slot 1417, and the extension portion 1540 is folded upward and juxtaposed to the back side (the rear light guide surface 144 or the rear reflective surface 134) of the light guide plate 140 to electrically connect the battery 120 located on the back side of the light guide plate 140. The slot 1417 solves the problem of electrical connection when the flexible printed circuit 150 is provided on the front side of the light guide plate 140 while the battery is arranged on the opposite back side of the light guide plate 140. As an example, the light guide plate 140 may be made of a plastic material such as a general-purpose polyethylene (GPPS), or polystyrene (PS).

Referring now to FIGS. 1D and 1F-1G, the back side (namely, the rear light guide surface 144) of the light guide plate 140 comprising the light guide portion 1410 and the receiving portion 1420 is shown (FIG. 1D). The rear light guide surface 144 further comprises an outer frame 1432 and a central indent portion 1430. The reflective layer 130 and the back plate 110 are contoured to be recessed into the outer frame 1432. The central indent portion 1430 and the sealing surface 112 of the back plate 110 may be attached together by means of, for example, a waterproof sticker or heat sealing to form a sealed space for accommodating the reflective layer 130 and the at least one battery 120. The light-emitting label has a smaller overall thickness and a better waterproof performance. As an example, the reflective layer 130 and the back plate 110 are sized and shaped to fit in the central indent portion 1430. In this embodiment, the light guide portion 1410 comprises a plurality of dots capable of scattering the light generated from the plurality of light-emitting diodes, as shown in FIG. 1G. The plurality of dots are equally spaced to form a light guide dot matrix. As an example, each dot is a disk-shaped protrusion formed on the rear light guide surface 144. As an example, each dot may be a protrusion protruding from the rear light guide surface 144. As an example, each dot may be a recess recessed from the rear light guide surface 144. As an example, each dot may be flat printed on the rear light guide surface 144 or formed by laser engraving. In other embodiments, the plurality of dots have different sizes, shapes and arrangement methods designed specially to achieve a uniform-luminosity light-emitting effect. In this embodiment, the light guide portion 1410 comprises a first dot portion 1411, a second dot portion 1412, a third dot portion 1413, and a fourth dot portion 1414 (FIG. 1F) consecutively arranged from bottom to top. Each dot portion comprises a plurality of equidistantly spaced, uniformly sized dots which scatter the light generated from the plurality of light-emitting diodes, wherein the sizes of a plurality of dots in each dot portion increase with increasing distance from the light-emitting diodes. As shown in FIGS. 1G (1)-(4), the diameter Φ of each dot of the first dot portion 1411 is about 0.2 mm, the diameter Φ of each dot of the second dot portion 1412 is about 0.3 mm, the diameter Φ of each dot of the third dot portion 1413 is about 0.4 mm, the diameter Φ of each dot of the fourth dot portion 1414 is about 0.5 mm, and the vertical and horizontal distances between the centers of any two closest dots in each dot portion are both 0.5 mm. As an example, the light guide portion 1410 may not comprise a plurality of dots capable of scattering the light generated from the plurality of light-emitting diodes.

Referring now to FIG. 1E, in this embodiment, the light-emitting label 100 provides a light source only with a plurality of light-emitting diodes arranged in one row, and saves more energy and is more environmentally friendly compared with the case of providing a light source with light-emitting diodes that arranged in multiple rows (such as in two rows, namely in an upper horizontal row and a lower horizontal row, or even in three or four rows along four sides of the light guide portion 1410). The inventors have found that if the light-emitting label 100 provides the light source only with a plurality of light-emitting diodes arranged in one row, the plurality of dots of the light guide portion 1410 and the specific size, shape and arrangement of the light guide dot matrix play a key role in achieving the uniform-luminosity light-emitting effect.

Referring now to FIGS. 1C-1D, the flexible printed circuit 150 is composed of a flexible substrate and an electronic element, and comprises a substrate surface 152 on the front side and an electrically-conductive surface 154 on the back side. The electrically-conductive surface 154 comprises a plurality of light-emitting diodes 1542 arranged on the substrate. As an example, the electrically-conductive surface 154 may further comprise other electronic elements such as a capacitor, a control integrated circuit, and a resistor. In this embodiment, the substrate surface 152 is substantially insulated and opaque. In this embodiment, the flexible printed circuit 150 is configured such that the plurality of light-emitting diodes 1542 are arranged in one row at equal intervals, and other electronic elements may be distributed between the plurality of light-emitting diodes to achieve a uniform light-emitting effect. In this embodiment, the flexible printed circuit 150 is horizontally arranged close to a lower edge of the light guide plate 140. In other embodiments, the flexible printed circuit 150 may be arranged close to any edge of the light guide plate 140, such as an upper edge, a lower edge, a left edge and/or a right edge. As an example, multiple rows (such as two rows, three rows, or four rows) of light-emitting diodes may be provided along edges of the light guide plate 140. As an example, the light-emitting label 100 may comprise two flexible printed circuits respectively provided close to the upper and lower portions of the light guide plate 140, and each flexible printed circuit comprises a plurality of light-emitting diodes. As an example, the flexible printed circuit 150 may further comprise a switch such as a push switch or a microswitch. It is advantageous that the flexible printed circuit 150 is arranged on the front side of the light guide plate 140 so that the substrate surface 152 faces the front side (namely, the pattern layer 160) while the electrically-conductive surface 154 (and the plurality of light-emitting diodes 1542 arranged thereon) faces the back side (namely, the front light guide surface 142 of the light guide plate 140), because the opaque substrate blocks the light emitted by the plurality of light-emitting diodes 1542 from being directly transmitted to the front side (namely, the pattern layer 160). A local light spot region and a local shadow region generated by direct light beams are avoided, the available area of the uniform light guide part is greatly increased, and the overall light-emitting effect is more uniform. As an example, the electrically-conductive surface 154 is positioned to be juxtaposed to the front light guide surface 142, the plurality of light-emitting diodes extend into the receiving portion 1420, and the push switch is provided in the middle recessed portion, such that the plurality of light-emitting diodes 1542 emit the light in a direction of the distal side, and the overall light-emitting effect is more uniform. As an example, when the flexible printed circuit 150 is arranged at the receiving portion 1420 and the electrically-conductive surface 154 is positioned to be juxtaposed to the front light guide surface 142, the substrate surface 152 is substantially flush with the front side of the light guide portion 1410, so that the overall thickness of the light-emitting label is decreased, the electronic element and the switch are sealed by the substrate, and the label has a better waterproof sealing effect and is more attractive as a whole.

Referring now to FIGS. 1A and 1C-1D, the pattern layer 160 is sized and shaped to sufficiently cover the front light guide surface 142 of the light guide plate 140. In other embodiments, the specific pattern, size and shape of the pattern layer 160 may be adjusted according to actual demands. As an example, the pattern layer 160 may comprise a pattern such as a bottle mark and allow light to be emitted from a front surface of the light-emitting label. As an example, the pattern layer 160 may comprise a light transmitting portion, a semi-light transmitting portion and/or an opaque portion. The pattern layer 160 fixes the flexible printed circuit 150 onto the front light guide surface 142. As an example, the back side of the pattern layer 160 comprises an adhesive layer to adhere the flexible printed circuit 150 to the front light guide surface 142. As an example, the pattern layer 160 may be made of a plastic film such as a PET film.

Referring now to FIG. 1H, a schematic perspective view of the light-emitting label 100 assembled to the target surface of the container 180 is shown. In this embodiment, the bracket 170 is fixed to the target surface of the container 180, and the light-emitting label 100 is removably and indirectly attached to the target surface of the container 180 by means of a fastener matched with the bracket 170, thereby facilitating assembly and removal. As an example, the light-emitting label may be attached directly or indirectly to the target surface of the container 180 in other manners such as adhesion, interlocked engagement, and/or mechanical engagement. In other embodiments, the target surface is not only limited to a container, but may be a surface of any object. As an example, the target surface may be a wall.

### Embodiment II

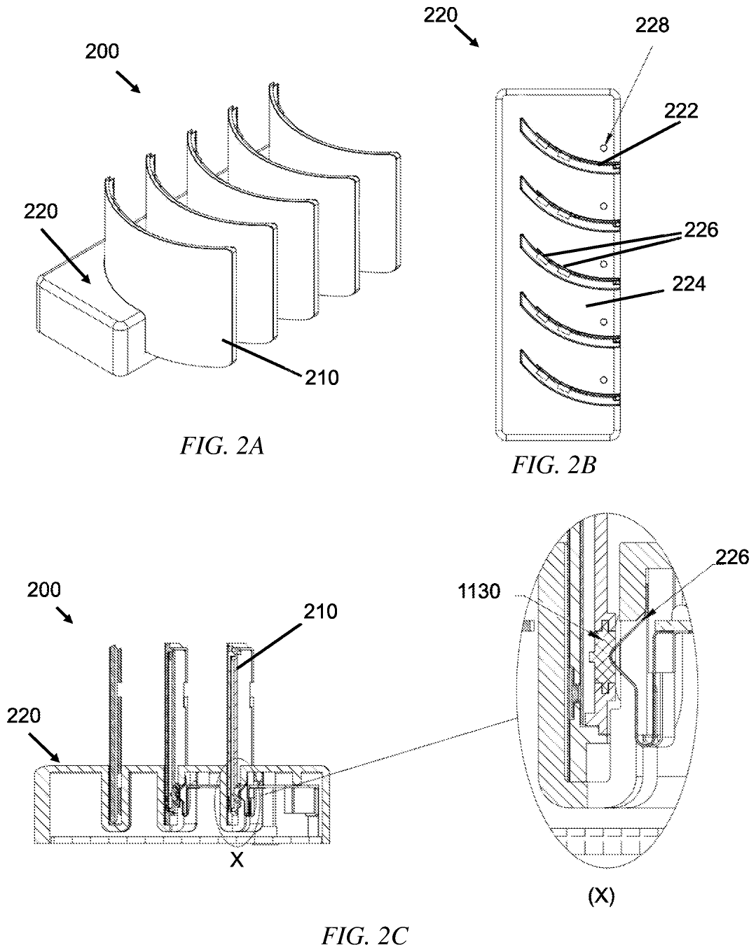

Referring now to FIGS. 2A-2C, shown is a light-emitting label system 200, comprising one or more light-emitting labels 210 and a charger 220. The charger 220 is configured to removably receive and electrically connect the one or more light-emitting labels 210 so as to charge each battery (not shown) in the one or more light-emitting labels 210. As an example, the battery is a rechargeable battery such as a lithium battery or a lithium polymer battery. The charger 220 may comprise a housing 224, one or more insertion slots 222, one or charging indicator lamps 228, one or more pairs of contact elements 226, and a charging component (not shown) arranged in the housing 224. The charging component may be electrically connected to a power source (not shown). In this embodiment, the charger 220 comprises five groups of insertion slots 222 contoured to be matched with at least a part of the light-emitting label so as to removably receive one to five light-emitting labels 210. When the charger 220 receives the light-emitting label 210, the contact elements 226 are in electrical contact with the charging contacts 1130 of the corresponding light-emitting label 210, so that the battery can be charged by the charging component, and multiple light-emitting labels can be conveniently used simultaneously to save the cost and protect the environment. As an example, the contact element 226 may be a charging pin having a spring.

### Embodiment III

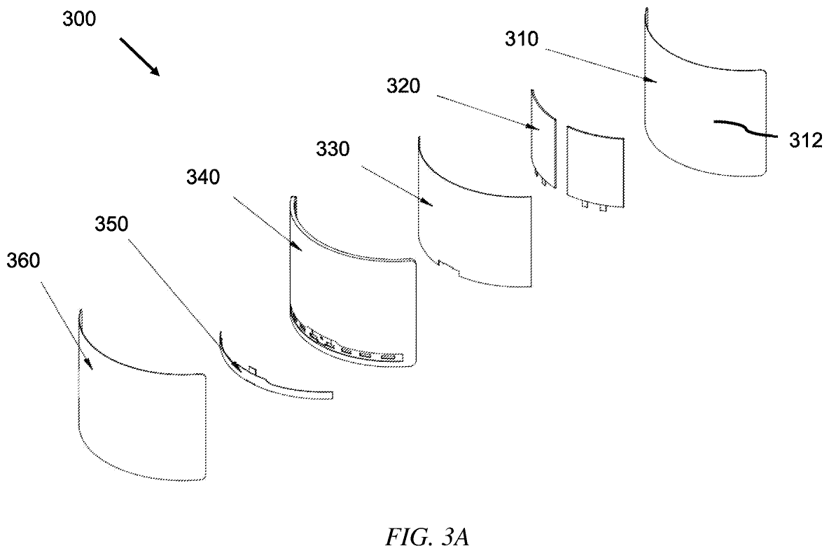

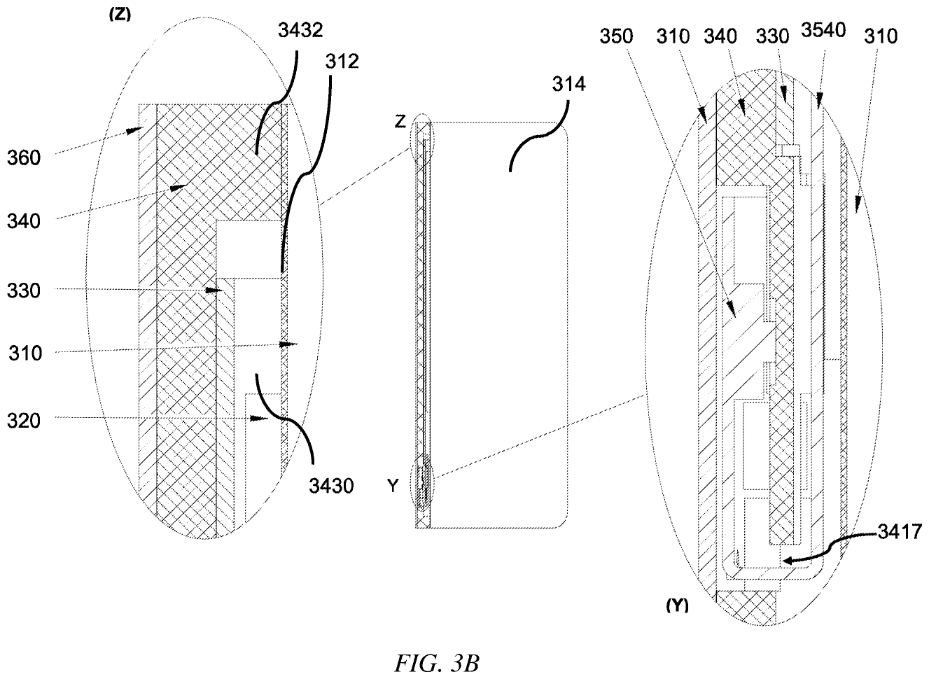

Referring now to FIGS. 3A-3B, a light-emitting label 300 of another embodiment is shown, which is formed by a plurality of layers, and sequentially comprises from the back side to the front side: a back plate 310, two batteries 320, a reflective layer 330, a light guide plate 340, a flexible printed circuit 350, and a pattern layer 360. As an example, the plurality of layers may be attached together by means of pasting and/or ultrasonic welding, and the light-emitting label 300 may be directly attached to a target surface. In these embodiment, the light-emitting label 300 is generally in the shape of a curved, rounded rectangle. In this embodiment, the back plate 310 comprises a front sealing surface 312 and an opposite target attachment surface 314. The light guide plate 340 comprises a central indent portion 3430 and an outer frame 3432. As an example, the back plate 310 has a double-sided adhesive layer, the back plate 310 is attached to the outer frame 3432 to seal the light guide plate 340 so as to form a space, in which the two batteries 320 are accommodated, and the batteries 320 may be attached to the sealing surface 312 (FIG. 3B). The back plate 310 seals the batteries 320 on the back side of the light guide plate 340. As an example, the back plate 310 is a waterproof adhesive layer or a waterproof sticker. In this embodiment, the two thin and flexible batteries 320 and the waterproof sticker serving as the back plate 310 are used, so that the light-emitting label 300 has a smaller overall thickness and a good waterproof performance. For example, the overall thickness of the light-emitting label 300 is only about 2.1-2.5 mm. As an example, the battery 320 may be a lithium battery or a lithium polymer battery such as a lithium-manganese dioxide battery. As an example, the battery capacity may range from 100 mAh to 400 mAh or range from 150 mAh to 350 mAh, depending on the size of the light-emitting label, the number of light-emitting diodes and actual demands. An extension portion 3540 of the flexible printed circuit 350 passes through the light guide plate 340 through a slot 3417 and is folded upward so as to be juxtaposed to the back side of the light guide plate 340, so as to be electrically connected to the battery 320 (FIG. 3B) located on the back side of the light guide plate 340.

### Embodiment IV

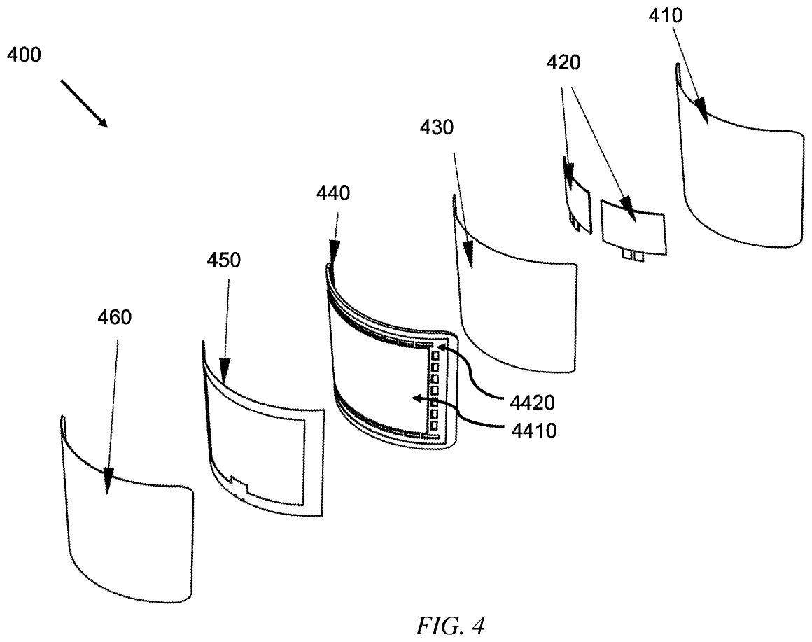

Referring now to FIG. 4, a light-emitting label 400 of another embodiment is shown, which is formed by a plurality of layers, and sequentially comprises from the back side to the front side: a back plate 410, two batteries 420, a reflective layer 430, a light guide plate 440, a flexible printed circuit 450, and a pattern layer 460. As an example, the plurality of layers may be attached together by means of pasting, heat sealing and/or ultrasonic welding. In this embodiment, the back plate 410, the light guide plate 440, and the pattern layer 460 are generally in the shape of a curved, rounded trapezoid, so that the light-emitting label 400 is generally also in the shape of a curved, rounded trapezoid, so as to be adaptively attached to a target surface. As an example, the back plate 410 is a double-sided adhesive layer, and the light-emitting label 400 may be directly attached or adhered to the target surface. The back plate 410 seals the light guide plate 440 to form a space, in which the two batteries 420 are accommodated. The back plate 410 seals the batteries 420 on the back side of the light guide plate 440. As an example, the back plate 410 is a waterproof adhesive layer or a waterproof sticker. In this embodiment, the two thin and flexible batteries 420 and the waterproof sticker serving as the back plate 410 are used, so that the light-emitting label 400 can have a smaller overall thickness. For example, the overall thickness of the light-emitting label 400 may reach about 2.1 mm or less. For example, the overall thickness of the light-emitting label 400 is only about 2.1-2.5 mm. As an example, the overall thickness of the light-emitting label 400 is only about 2.1 mm. As an example, the battery 420 may be a lithium battery or a lithium polymer battery such as a lithium-manganese dioxide battery. In this embodiment, a flexible printed circuit 450 which is substantially a trapezoidal frame is used, and a plurality of light-emitting diodes (not shown) arranged in four rows along four edges of the light guide plate 440 are arranged on an electrically-conductive surface (not shown) on the back side. As an example, one or more rows (such as, two rows, three rows, or four rows) of light-emitting diodes arranged along the edge(s) of the light guide plate and one or more rows of corresponding through holes may be provided. Correspondingly, the four edges of the light guide plate 440 are provided with a receiving portion 4420 matched with the trapezoidal frame of the flexible printed circuit 450, and the light guide portion is located in the receiving portion 4420. Due to the fact that the plurality of light-emitting diodes are arranged on the four edges of the light guide plate, a uniform light source is provided. As an example, the light guide plate 440 may not comprise a plurality of light guide dots or dot matrices. As an example, the light guide plate may comprise three dot portions, and the sizes of a plurality of dots in each dot portion increase with increasing distance from the light-emitting diodes. In other embodiments, the reflective layer 530 may not be comprised.

### Embodiment V

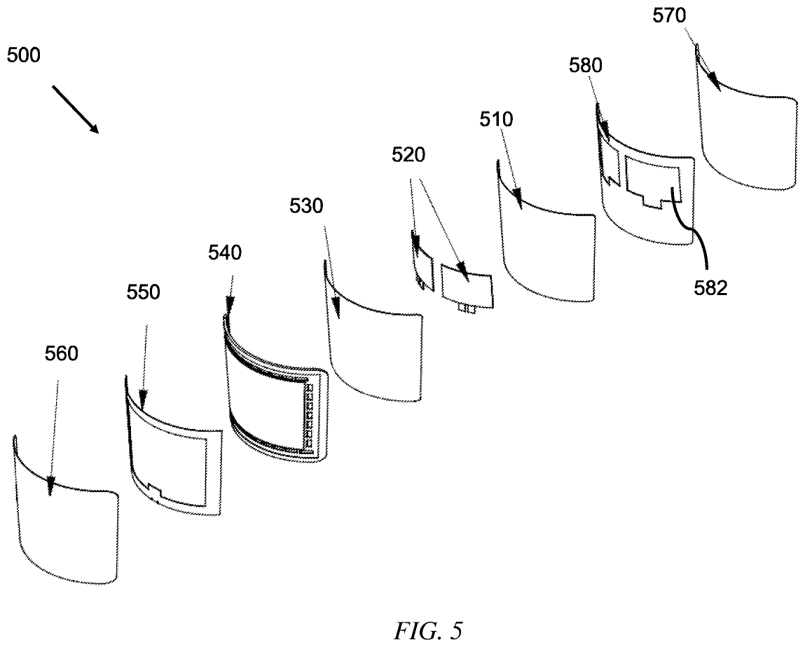

Referring now to FIG. 5, a light-emitting label 500 of another embodiment is shown, which is formed by a plurality of layers, and sequentially comprises from the back side to the front side: an adhesion layer 570, an interlayer 580, a back plate 510, two batteries 520, a reflective layer 530, a light guide plate 540, a flexible printed circuit 550, and a pattern layer 560. Compared with Embodiment III, the light-emitting label 500 of this embodiment additionally comprises an interlayer 580 and an adhesion layer 570, the interlayer 580 is located between the back side of the back plate 510 and the front side of the adhesion layer 570, and the adhesion layer 570 is located on the back side of the interlayer 580. The back side of the adhesion layer 570 is adaptively attached to any target surface, including an uneven target surface. As an example, the adhesion layer 570 may be a double-sided tape to adhere the interlayer 580 to the back plate 510 and the target surface. As an example, the adhesion layer 570 is a waterproof adhesion layer or a waterproof sticker. As an example, the interlayer 580 may have a thickness and comprise two grooves or penetrating holes 582 adapted to contours of the batteries 520, which may accommodate at least a part of the batteries 520 in the interlayer 580, allowing the light-emitting label 500 to use batteries that are larger in electric capacity but larger in thickness, and so that the service life is longer, and the overall structure is still compact and attractive. As an example, the interlayer 580 may be a foam layer such as an EVA foam layer. In other embodiments, the interlayer 580, the adhesion layer 570 and/or the reflective layer 530 may not be comprised.

### Embodiment VI

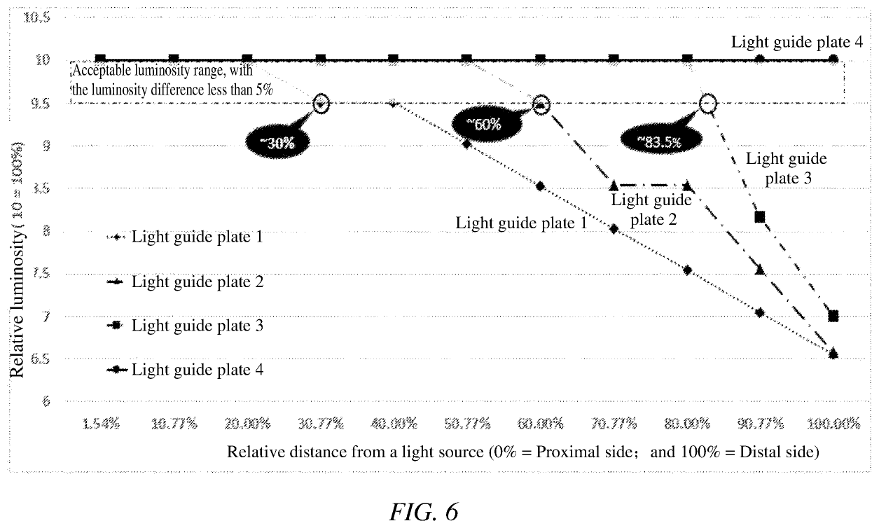

In an embodiment, the light-emitting effects of light guide plates having different dot matrix arrangements are compared. Four light guide plate samples of the same size but have different dot matrix arrangements are prepared in the same manner from the same material, each sample provides a light source having the same luminosity by means of the same number of light-emitting diodes with the same parameters that are arranged in a row, and the light-emitting effect of the relative luminosity at the position between a proximal side and a distal side is then obtained using an optical system simulation software. Table 1 below shows parameters of specific dot matrix arrangements of the four light guide plate samples. Referring now to FIG. 6, it is found that the light guide plate 1, the light guide plate 2 and the light guide plate 3 respectively begin to have a luminosity reduction at relative positions about 30%, about 60% and about 83.5% of a relative distance from a light source (relative positions of the proximal side and the distal side). That is, compared with the proximal-side luminosity, the relative luminosity at the relative position is 95% or below of the proximal-side luminosity (with a luminosity difference less than 5%). The light guide plate 4 (comprising four dot portions, with the area ratio of the dot portions being about 21:28:28:23) has the most ideal effect, and the difference between the proximal-side luminosity and the distal-side luminosity is less than 5%, that is, the luminosity over the entire length defined between the proximal side and the distal side remains high and substantially uniform.

TABLE 1
Parameters of light guide plate samples having different dot matrix
arrangements Embodiment VII

| | | | Dia- | Area | |
|---|---|---|---|---|---|
| Light guide | Number | | meter | percentage | Area ratio |
| plate | of dot | | of dot | of dot | of dot |
| sample | portions | Dot portion | (mm) | portions (%) | portions |
| Light guide | 1 | First dot | 0.2 | 100.00 | Not |
| plate 1 | | portion | | | applicable |
| Light guide | 2 | First dot | 0.2 | 50.00 | 1:1 |
| plate 2 | | portion | | | |
| | | Second dot | 0.3 | 50.00 | |
| | | portion | | | |
| Light guide | 3 | First dot | 0.2 | 20.86 | 21:40:39 |
| plate 3 | | portion | | | |
| | | Second dot | 0.3 | 40.07 | |
| | | portion | | | |
| | | Third dot | 0.4 | 39.07 | |
| | | portion | | | |
| Light guide | 4 | First dot | 0.2 | 20.88 | 21:28:28:23 |
| plate 4 | | portion | | | |
| | | Second dot | 0.3 | 28.07 | |
| | | portion | | | |
| | | Third dot | 0.4 | 28.07 | |
| | | portion | | | |
| | | Fourth dot | 0.5 | 22.98 | |
| | | portion | | | |

In another aspect, the light-emitting label is manufactured according to one or more of the following steps:
1. A back plate, at least one battery, a light guide plate, a flexible printed circuit, and a pattern layer are provided. The light guide plate comprises a front light guide surface and an opposite rear light guide surface, a light guide portion, a receiving portion, and a slot. The flexible printed circuit comprises a substrate surface and an opposite electrically-conductive surface. The electrically-conductive surface comprises a plurality of light-emitting diodes arranged thereon.
2. The electrically-conductive surface is positioned to be juxtaposed to the front light guide surface such that the plurality of light-emitting diodes extend into the receiving portion.
3. The flexible printed circuit is electrically connected, through the slot, to the at least one battery arranged at the rear light guide surface.
4. The flexible printed circuit is fixed onto the front light guide surface by the pattern layer.
5. The at least one battery is sealed onto the rear light guide surface by the back plate.
6. Optionally, a reflective layer is provided. The reflective layer may be attached to the rear light guide surface.
7. Optionally, an interlayer and an adhesion layer are provided. The interlayer may be attached to the back plate by means of the adhesion layer.

The preferred embodiments of the present application are described above with reference to the accompanying drawings, and the scope of rights of the present application is not limited thereby. Those skilled in the art can implement the present application in many variation solutions without departing from the scope and essence of the present application. For example, features of one embodiment can be used in another embodiment to obtain a further embodiment. Any modification, equivalent replacement and improvement made within the technical conception of the present application shall fall within the scope of rights of the present application.

1. A light-emitting label, which comprises:
(a) a back plate comprising a sealing surface and a target attachment surface opposite to the sealing face;
(b) at least one battery;
(c) a light guide plate comprising a front light guide surface and a rear light guide surface opposite to the front light guide surface;
(d) a flexible printed circuit comprising a substrate surface and an electrically-conductive surface opposite to the substrate surface, the electrically-conductive surface comprising a plurality of light-emitting diodes arranged on the electrically-conductive surface; and
(e) a pattern layer;
wherein
the pattern layer fixes the flexible printed circuit onto the front light guide surface, and
the back plate seals the at least one battery onto the rear light guide surface;
the light guide plate further comprises:
a light guide portion comprising a proximal side and a distal side between which a length is defined; and
a receiving portion shaped and sized to receive the flexible printed circuit;
the electrically-conductive surface is positioned to be juxtaposed to the front light guide surface, and the plurality of light-emitting diodes extend into the receiving portion such that the plurality of light-emitting diodes emit light in a direction of the distal side; and
the light guide plate further comprises:
a slot for allowing the flexible printed circuit to be electrically connected to the at least one battery.

2. The light-emitting label according to claim 1, wherein the rear light guide surface further comprises a central indent portion, and the central indent portion and the sealing surface form a space for accommodating the at least one battery.

3. The light-emitting label according to claim 1, further comprising a reflective layer, the reflective layer comprising:
a front reflective surface attached to the rear light guide surface; and
a rear reflective surface attached to the at least one battery and/or the sealing surface.

4. The light-emitting label according to claim 1, wherein the plurality of light-emitting diodes are arranged in a row at equal intervals; and the flexible printed circuit further comprises a push switch disposed proximal to the center of the row.

5. The light-emitting label according to claim 1, wherein the back plate is or comprises a double-sided sticker or a removable sticker.

6. The light-emitting label according to claim 1, further comprising a wireless charging component.

7. The light-emitting label according to claim 1, wherein the light-emitting label is configured to be detachably received in a bracket attachable to a target surface.

8. The light-emitting label according to claim 1, wherein the at least one battery is rechargeable, and the back plate is configured to electrically connect the at least one battery to a charger.

9. The light-emitting label according to claim 1, wherein the light guide portion comprises a plurality of dot portions which are consecutively arranged, wherein the sizes of a plurality of dots in each dot portion increase with increasing distance from the light-emitting diodes.

10. The light-emitting label according to claim 1, wherein the light guide portion further comprises: a first dot portion, a second dot portion, a third dot portion and a fourth dot portion which are consecutively arranged with increasing distance from the plurality of light-emitting diodes,
wherein each dot portion comprises a plurality of equidistantly spaced, uniformly sized dots which scatter the light generated from the plurality of light-emitting diodes, wherein the sizes of a plurality of dots in each dot portion increase with increasing distance from the light-emitting diodes.

11. The light-emitting label according to claim 10, wherein the diameters of the dots in the first dot portion, the second dot portion, the third dot portion and the fourth dot portion are respectively 0.2 mm, 0.3 mm, 0.4 mm and 0.5 mm, and the vertical and horizontal distances between the centers of any two closest dots are both 0.5 mm.

12. The light-emitting label according to claim 11, wherein the surface area ratio of the first dot portion to the second dot portion to the third dot portion to the fourth dot portion is 21:28:28:23.

13. The light-emitting label according to claim 1, wherein the light-emitting label is generally in the shape of a curved surface.

14. The light-emitting label according to claim 1, wherein the light-emitting label is generally in the shape of a trapezoidal curved surface.

15. A light-emitting label, which comprises:
(a) a back plate comprising a sealing surface and an opposite target attachment surface;
(b) at least one battery;
(c) a reflective layer comprising a front reflective surface and a rear reflective surface;
(d) a light guide plate comprising a front light guide surface and an opposite rear light guide surface;
(e) a flexible printed circuit comprising a substrate surface and an opposite electrically-conductive surface, the electrically-conductive surface comprising a plurality of light-emitting diodes arranged thereon; and
(f) a pattern layer;
wherein
the pattern layer fixes the flexible printed circuit onto the front light guide surface,
the back plate seals the reflective layer and the at least one battery onto the rear light guide surface, and
the front reflective surface is juxtaposed to the rear light guide surface;
the light guide plate further comprises:
a light guide portion, comprising a proximal side and a distal side between which a length is defined, and comprising a plurality of dots for scattering light generated from the plurality of light-emitting diodes; and
a receiving portion shaped and sized to receive the flexible printed circuit;
the electrically-conductive surface is positioned to be juxtaposed to the front light guide surface, and the plurality of light-emitting diodes extend into the receiving portion such that the plurality of light-emitting diodes emit light in a direction traversing across the length; and
the light guide plate further comprises:
an insertion slot for allowing the flexible printed circuit to be electrically connected to the at least one battery.

16. A light-emitting label system, comprising:
one or more light-emitting labels of claim 1; and
a charger configured to removably receive and electrically connect the one or more light-emitting labels so as to charge the at least one battery in each of the one or more light-emitting labels.
